(19) United States
(12) Patent Application Publication
(10) Pub. No.: US 2016/0040513 A1
(43) Pub. Date: Feb. 11, 2016

(54) HYBRID RESERVOIR BRINE MODEL

(71) Applicants: Christopher J. Freitas, San Antonio, TX (US); Nicholas J. Mueschke, San Antonio, TX (US); Nathan F. Andrews, San Antonio, TX (US)

(72) Inventors: Christopher J. Freitas, San Antonio, TX (US); Nicholas J. Mueschke, San Antonio, TX (US); Nathan F. Andrews, San Antonio, TX (US)

(73) Assignee: BAKER HUGHES INCORPORATED, Houston, TX (US)

(21) Appl. No.: 14/451,608

(22) Filed: Aug. 5, 2014

(51) Int. Cl. E21B 43/00; G01V 11/00

(52) U.S. Cl. CPC E21B 43/00; G01V 11/00

(57) ABSTRACT

A method of estimating saturation conditions of reservoir brines in an underground reservoir includes: receiving data representing a temperature of the brine; determining if the temperature is greater than a preset value; and selecting either a first method or second method, different than the first method, of calculating the saturation conditions based on the determination. The first method is selected when the temperature is greater than the preset value and the second method is selected when the temperature is less than the preset value.

### TECHNICAL FIELD

This invention is pertinent to the thermodynamic modeling of multicomponent mixtures and the calculation of a mixture's phase state at different pressures and temperatures and may utilize a two-phase flash algorithm that employs cubic equation of state (EOS) models. Specifically, this invention addresses the problem of two-phase cubic EOS models falsely identifying vapor/liquid multiphase splits at relatively low temperatures where no such vapor phase may physically exist.

### BACKGROUND

Thermodynamic equation of state (EOS) models relates known state variables, such as pressure and temperature, to unknown state variables, such as volume, density, fugacity, etc. In addition they may be used to determine the phase state of a given pure substance or multicomponent mixture. Cubic EOS models are a subclass of thermodynamic EOS models that relate pressure, temperature, and molar volume through a cubic polynomial function. Cubic EOS models are used to predict phase behavior and fluid properties in a broad range of applications, including the petrophysical, geophysical, refrigeration, aerospace, and chemical process design industries. Their broad adoption and application is due to the relative simplicity of the model form, ease of computational implementation, limited number of fluid property inputs required for operation, and overall computational robustness.

The cubic EOS model subclass was first developed by van der Waals (1873) as an extension to the ideal gas law, where both attractive and repulsive molecular forces are included. In the van der Wall model, pressure, temperature, and volume are related as

$$P = \frac{RT}{V - b} - \frac{a}{{V}^{2}} , \qquad ( 1.1 )$$

where R is the universal gas constant, and a and b are attractive and repulsive parameters specific to each pure substance or mixture. Since the initial formulation of a cubic EOS model by van der Waals, numerous modifications to the model form have been made in an effort to increase predictive accuracy and general applicability. Of note are the Redlich-Kwong (RK) modification to the attractive term creating the RK cubic EOS model, the Soave modification to the Redlich-Kwong attractive term creating the SRK cubic EOS, and the Peng-Robinson (PR) modification creating the PR cubic EOS. Widespread adoption and application of cubic EOS models came about with the advent of the SRK and PR cubic EOS models, which may be expressed in a universal form:

$$P = \frac{RT}{V - b} - \frac{a α}{{V}^{2} + {u}_{1} bV + {u}_{2} {b}^{2}} , \qquad ( 1.2 )$$

where the values and model forms for a, α, b, u₁, and u₂ are listed in Table 1. Expressed in its cubic polynomial form, all four models may be written as:

$$\begin{matrix}{Z}^{3} - ( \begin{matrix}1 + B - \\ {u}_{1} B\end{matrix} ) {Z}^{2} + ( \begin{matrix}A + {u}_{2} {B}^{2} - \\ {u}_{1} B - {u}_{1} {B}^{2}\end{matrix} ) Z - ( \begin{matrix}AB + {u}_{2} {B}^{2} + \\ {u}_{2} {B}^{3}\end{matrix} ) = 0 , & ( 1.3 ) \\ where & \\ A = \frac{{( a α )}_{mix} P}{{R}^{2} {T}^{2}} and B = \frac{{b}_{mix} P}{RT} . & ( 1.4 )\end{matrix}$$

Attractive and repulsive terms for mixtures are calculated using the mixing rules:

$$\begin{matrix}{( a α )}_{mix} = {\sum }_{i}^{N} {\sum }_{j}^{N} [ {x}_{i} {x}_{j} \sqrt{{a}_{i} {a}_{j} {α}_{i} {α}_{j}} ( 1 - {k}_{ij} ) ] , & ( 1.5 ) \\ {b}_{mix} = {\sum }_{i}^{N} {x}_{i} {b}_{i} , & ( 1.6 )\end{matrix}$$

where xᵢ is the mole fraction of each component in the phase of interest (liquid or gas) and kᵢⱼ are binary interaction coefficients.

TABLE 1
Cubic EOS parameters.

| Model | a | α | b | Ωₐ | Ω_{b} | u₁ | u₂ |
|---|---|---|---|---|---|---|---|
| Van der Waals | $\frac{27}{26} \frac{{R}^{2} {T}_{c}^{2}}{{P}_{c}}$ | 1 | $\frac{{RT}_{c}}{8 {P}_{c}}$ | n/a | n/a | 0 | 0 |
| RK | $\frac{{Ω}_{a} {R}^{2} {T}_{c}^{2}}{{P}_{c}}$ | Tᵣ^{-0.5} | $\frac{{Ω}_{b} {RT}_{c}}{{P}_{c}}$ | 0.42748 | 0.08664 | 1 | 0 |
| SRK | $\frac{{Ω}_{a} {R}^{2} {T}_{c}^{2}}{{P}_{c}}$ | [1 + f_{ω}(1 − Tᵣ^{0.5})]² f_{ω} = 0.48 + 1.574ω − 0.176ω² | $\frac{{Ω}_{b} {RT}_{c}}{{P}_{c}}$ | 0.42748 | 0.08664 | 1 | 0 |
| PR | $\frac{{Ω}_{a} {R}^{2} {T}_{c}^{2}}{{P}_{c}}$ | [1 + f_{ω}(1 − Tᵣ^{0.5})]² f_{ω} = 0.37464 + 1.54226ω − 0.2699ω² | $\frac{{Ω}_{b} {RT}_{c}}{{P}_{c}}$ | 0.45724 | 0.07780 | 2 | −1 |

Provided physical properties for each mixture component, a cubic EOS may be used to calculate the compressibility factor Z for each potential phase (liquid and vapor phases). However, the determination of the phase state (liquid, vapor, or some combination of each) is a function of the fugacity of each component. Vapor-liquid equilibrium is achieved when the fugacity of the vapor phase (real or potential vapor phase) and the fugacity of the liquid phase (real or potential liquid phase) are equal for each component in the mixture

fᵢ^{liq}=fᵢ^{vap} (1.7)

This may also be expressed in the form of the equilibrium ratio:

$${K}_{i} = \frac{{y}_{i}}{{x}_{i}} \frac{{f}_{i}^{liq}}{{f}_{i}^{vap}} = \frac{{ϕ}_{i}^{liq}}{{ϕ}_{i}^{vap}} \qquad ( 1.8 )$$

where φᵢ^{liq}=fᵢ^{liq}/xᵢP is the liquid-phase fugacity coefficient and φᵢ^{vap}=fᵢ^{vap}/yᵢP is the vapor-phase fugacity coefficient. The fugacity coefficient of each component may be calculated by

$$ln ( {ϕ}_{i}^{liq} ) = \frac{{b}_{i} ( {Z}_{liq} - 1 )}{{b}_{mix}} - ln ( {Z}_{liq} - {B}_{liq} ) - \frac{{A}_{liq}}{{B}_{liq} ( {δ}_{2} - {δ}_{1} )} ( \frac{2 {Ψ}_{i}^{liq}}{{( a α )}_{mix}} - \frac{{b}_{i}}{{b}_{mix}} ) ln ( \frac{{Z}_{liq} + {δ}_{1} {B}_{liq}}{{Z}_{liq} + {δ}_{2} {B}_{liq}} ) , \\ ln ( {ϕ}_{i}^{vap} ) = \frac{{b}_{i} ( {Z}_{vap} - 1 )}{{b}_{mix}} - ln ( {Z}_{vap} - {B}_{vap} ) - \frac{{A}_{vap}}{{B}_{vap} ( {δ}_{2} - {δ}_{1} )} ( \frac{2 {Ψ}_{i}^{vap}}{{( a α )}_{mix}} - \frac{{b}_{i}}{{b}_{mix}} ) ln ( \frac{{Z}_{vap} + {δ}_{1} {B}_{vap}}{{Z}_{vap} + {δ}_{2} {B}_{vap}} ) , \\ {Ψ}_{i}^{liq} = {\sum }_{j}^{N} [ {x}_{j} \sqrt{{a}_{i} {a}_{j} {α}_{i} {α}_{j}} ( 1 - {k}_{ij} ) ] , and \\ {Ψ}_{i}^{vap} = {\sum }_{j}^{N} [ {y}_{j} \sqrt{{a}_{i} {a}_{j} {α}_{i} {α}_{j}} ( 1 - {k}_{ij} ) ] . \qquad ( 5.9 )$$

For RK and SRK models, δ₁=1 and δ₂=0. For the PR model, δ₁=1+\sqrt{2} and δ₂=1−\sqrt{2}.

In order to determine the liquid/vapor quality of a mixture, the Rachford-Rice equations must be solved, which depend upon the composition of the mixture and the equilibrium ratio. The solution to the Rachford-Rice equation contains a physical solution, i.e., the mole fraction of vapor existing on the interval 0<nᵥₐₚ<1, if both g(0)≧1.0 and g(1)≧1.0 where

$$g ( 0 ) = {\sum }_{1}^{N} {z}_{i} {K}_{i} and g ( 1 ) = {\sum }_{1}^{N} \frac{{z}_{i}}{{K}_{i}} \qquad ( 1.10 )$$

If g(0)<1.0, then the substance or mixture is expected to exist entirely as a liquid-phase fluid. Conversely, if g(1)<1.0, then the substance or mixture is expected to exist entirely as a vapor-phase fluid. Thus, given values for the equilibrium ratio Kᵢ, this check allows for the EOS to determine the phase state of a substance or mixture. Since a priori knowledge of the Kᵢ is generally not available for any arbitrary mixture at any pressure-temperature state condition, the solution to a cubic EOS, property mixture rules, and fugacity formulation is performed in an iterative manner with an initial guess for Kᵢ provided. Typically, that initial seeding guess is provided by Wilson's Kᵢ:

$${K}_{i} = \frac{{P}_{c , i}}{P} exp [ 5.373 ( 1 + {ω}_{i} ) ( 1 - \frac{{T}_{c , i}}{T} ) ] \qquad ( 1.11 )$$

### SUMMARY

According to one embodiment, an apparatus for estimating saturation conditions of reservoir brines in an underground reservoir that includes a sensor for measuring a temperature of the brine a processor is disclosed. The processor is configured to: receive data representing the temperature; determine if the temperature is greater than a preset value; select either a first method or second method, different than the first method, of calculating the saturation conditions based on the determination; wherein the first method is selected when the temperature is greater than the preset value and the second method is selected when the temperature is less than the preset value; and based on results of the first or second method, form the saturation condition estimates utilizing an equation of state (EOS) model.

According to another embodiment, a computer based method of estimating saturation conditions of reservoir brines in an underground reservoir is disclosed. The method includes receiving at the computing device data representing a temperature of the brine; determining with the computing device if the temperature is greater than a preset value; selecting either a first method or second method, different than the first method, of calculating the saturation conditions based on the determination, wherein the first method is selected when the temperature is greater than the preset value and the second method is selected when the temperature is less than the preset value; and based on results of the first or second method, forming the saturation condition estimates utilizing an equation of state (EOS) model.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 shows an example drilling system according to one embodiment;

FIG. 2 is a diagram of the new hybrid model workflow;

FIG. 3 is a more detailed version of portions the flow diagram shown in FIG. 2; and

FIG. 4 is a more detailed version of portions the flow diagram shown in FIG. 2.

### DETAILED DESCRIPTION

In one embodiment, this invention addresses the problem of two-phase cubic EOS models falsely identifying vapor/liquid multiphase splits at relatively low temperatures where no such vapor phase may physically exist.

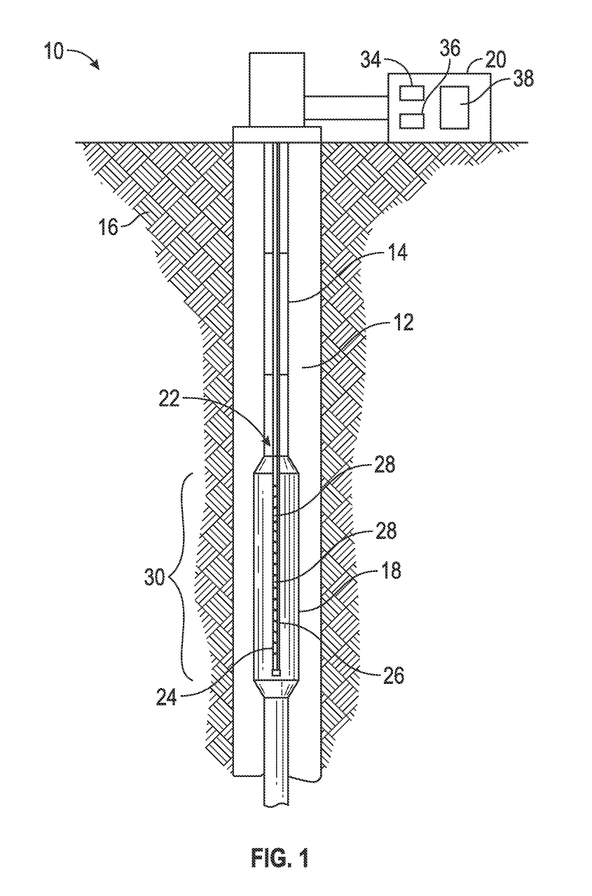

Referring to FIG. 1, an exemplary embodiment of a downhole drilling, monitoring, evaluation, exploration and/or production system 10 disposed in a wellbore 12 is shown. A borehole string 14 is disposed in the wellbore 12, which penetrates at least one earth formation 16 for performing functions such as extracting matter from the formation and/or making measurements of properties of the formation 16 and/or the wellbore 12 downhole. The borehole string 14 is made from, for example, a pipe, multiple pipe sections or flexible tubing. The system 10 and/or the borehole string 14 include any number of downhole tools 18 for various processes including drilling, hydrocarbon production, and measuring one or more physical quantities in or around a borehole. Various measurement tools 18 may be incorporated into the system 10 to affect measurement regimes such as wireline measurement applications or logging-while-drilling (LWD) applications.

In one embodiment, a parameter measurement system is included as part of the system 10 and is configured to measure or estimate various downhole parameters of the formation 16, the borehole 14, the tool 18 and/or other downhole components. The illustrated measurement system includes an optical interrogator or measurement unit 20 connected in operable communication with at least one optical fiber sensing assembly 22. The measurement unit 20 may be located, for example, at a surface location, a subsea location and/or a surface location on a marine well platform or a marine craft. The measurement unit 20 may also be incorporated with the borehole string 12 or tool 18, or otherwise disposed downhole as desired.

In the illustrated embodiment, an optical fiber assembly 22 is operably connected to the measurement unit 20 and is configured to be disposed downhole. The optical fiber assembly 22 includes at least one optical fiber core 24 (referred to as a “sensor core” 24) configured to take a distributed measurement of a downhole parameter (e.g., temperature, pressure, stress, strain and others). In one embodiment, the system may optionally include at least one optical fiber core 26 (referred to as a “system reference core” 26) configured to generate a reference signal. The sensor core 24 includes one or more sensing locations 28 disposed along a length of the sensor core, which are configured to reflect and/or scatter optical interrogation signals transmitted by the measurement unit 20. Examples of sensing locations 28 include fibre Bragg gratings, Fabry-Perot cavities, partially reflecting mirrors, and locations of intrinsic scattering such as Rayleigh scattering, Brillouin scattering and Raman scattering locations. If included, the system reference core 26 may be disposed in a fixed relationship to the sensor core 24 and provides a reference optical path having an effective cavity length that is stable relative to the optical path cavity length of the sensor core 24.

In one embodiment, a length of the optical fiber assembly 22 defines a measurement region 30 along which distributed parameter measurements may be taken. For example, the measurement region 30 extends along a length of the assembly that includes sensor core sensing locations 28.

The measurement unit 20 includes, for example, one or more electromagnetic signal sources 34 such as a tunable light source, a LED and/or a laser, and one or more signal detectors 36 (e.g., photodiodes). Signal processing electronics may also be included in the measurement unit 20, for combining reflected signals and/or processing the signals. In one embodiment, a processing unit 38 is in operable communication with the signal source 34 and the detector 36 and is configured to control the source 34, receive reflected signal data from the detector 36 and/or process reflected signal data.

In one embodiment, the measurement system is configured as a coherent optical frequency-domain reflectometry (OFDR) system. In this embodiment, the source 34 includes a continuously tunable laser that is used to spectrally interrogate the optical fiber sensing assembly 22.

The optical fiber assembly 22 and/or the measurement system are not limited to the embodiments described herein, and may be disposed with any suitable carrier. That is, while an optical fiber assembly 22 is shown, any type of now known or later developed manners of obtaining information relative a reservoir may be utilized to measure various information (e.g., temperature, pressure, salinity and the like) about fluids in a reservoir. Thus, in one embodiment, the measurement system may not employ any fibers at all and may communicate data electrically.

A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

In support of the teachings herein, various analysis components may be used, including a digital and/or an analog system. Components of the system, such as the measurement unit 20, the processor 38, the processing assembly 50 and other components of the system 10, may have components such as a processor, storage media, memory, input, output, communications link, user interfaces, software programs, signal processors (digital or analog) and other such components (such as resistors, capacitors, inductors and others) to provide for operation and analyses of the apparatus and methods disclosed herein in any of several manners well appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Disclosed is new hybrid PR EOS model for calculating brine saturation conditions. The hybrid model is formulated by the combination of two independent models. One model is the Søreide and Whitson (SW) modified PR EOS and the second is a new modified version of the PR EOS using the Haas correlation. Each of the original models will be described in greater detail below. However, as a general statement the purpose of combining the two models is to provide an accurate prediction of brine saturation conditions over the entire saturation boundary.

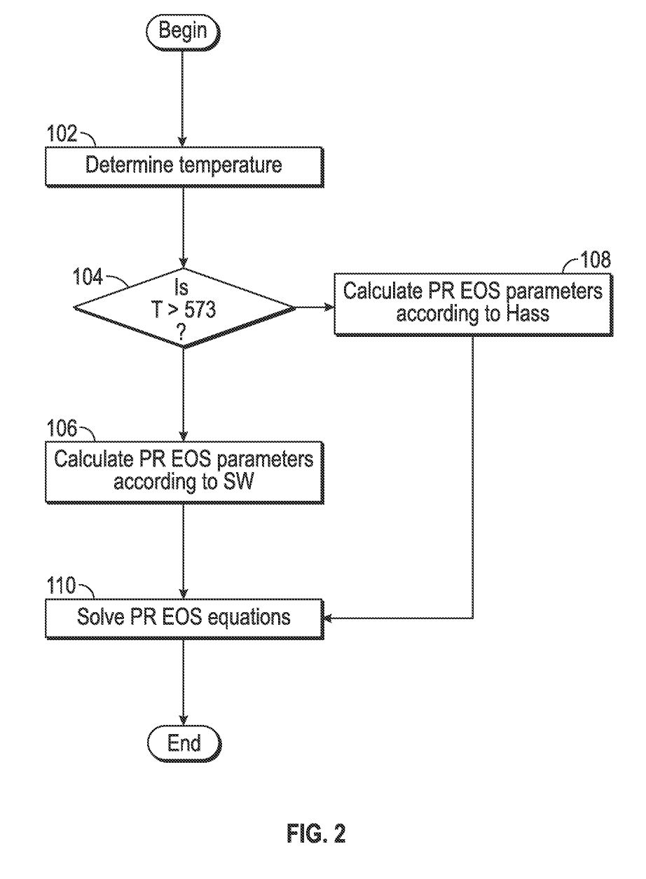

With reference to FIG. 2, at block 202 the temperature of the brine is determined. This may include any now known or later developed method of determining the temperature of a brine in a reservoir. For instance, the above described optical measurement system may be employed or another type of measurement system may be utilized.

In the event that the temperature is greater than 573, the PR EOS parameters are calculated according Hass as indicated by blocks 204 and 208, respectively. In the event that the temperature is less than 573, the PR EOS parameters are calculated according SW as indicated by blocks 204 and 206, respectively. Regardless of how the PR EOS parameters are calculated, at block 210 the PR EOS equations are solved to provide properties of reservoir water and brines.

In more detail, the correlation of Haas is a common and widely accepted model in the reservoir engineering community to calculate the saturation pressure and temperature conditions of reservoir brine. It provides a simple method to calculate the pressure and temperature of saturated brine with a high degree of accuracy compared to experimental data. Haas establishes that the temperature of pure water, T₀, and temperature of a brine solution of sodium chloride, Tₓ, at the same vapor pressure can be correlated by the following relation:

$$ln {T}_{0} = \frac{ln {T}_{x}}{a + b {T}_{x}} + c \qquad ( 1 )$$

where temperature is Kelvin and a, b and c are model variables. Haas used this model form to empirically generate the values of a and b, assuming c=0, with least-squares regression. These coefficients were described by the following formulas:

a=1.0+5.93582×10⁻⁶x−5.19386×10⁻⁵x²+1.23156×10⁻⁵x³ (2)

b=1.0+1.15420×10⁻⁶x+1.41254×10⁻⁷x²−1.92476×10⁴x³−1.70717×10⁻⁹x⁴+1.05390×10⁻¹⁰x⁵ (3)

where x is the molality of the brine solution. Once the saturation temperature of the brine, Tₓ, is obtained, the value of vapor pressure, Pᵥ (in bar), can be calculated by applying the following equation:

$$\begin{matrix}ln {P}_{v} = {e}_{0} + \frac{{e}_{1}}{z} + \frac{{e}_{2} w}{z} + [ {10}^{( {e}_{3} {w}^{2} )} - 1.0 ] + {e}_{4} [ {10}^{( {{e}_{5} ( y )}^{1.25} )} ] & ( 4 ) \\ where & \\ w = {z}^{2} - {e}_{6} \\ y = 647.27 - {T}_{0} \\ z = {T}_{0} + 0.01 \\ {e}_{0} = 12.50849 \\ {e}_{1} = - 4.616913 \times {10}^{3} \\ {e}_{2} = 3.193455 \times {10}^{- 4} \\ {e}_{3} = 1.1965 \times {10}^{- 11} \\ {e}_{4} = - 1.013137 \times {10}^{- 2} \\ {e}_{5} = - 5.7148 \times {10}^{- 3} \\ {e}_{6} = 2.9370 \times {10}^{5} . & ( 5 )\end{matrix}$$

Equations (1)-(5) result in a standard error for the prediction of the vapor pressure of sodium chloride solutions of 0.32% in reference to the experimentally observed pressure. These equations were developed for the range of sodium chloride concentration of 0 weight percent sodium chloride to halite saturation. Beyond the experimentally validated temperature range (262.15 to 573.15 K), the equations provide predictions which vary smoothly and continuously to higher temperatures. No error estimate outside the experimental temperature range is provided by Haas.

These equations have proven very useful in determining the saturation curves for brine solutions. However, one aspect to remember is that it is strictly a correlation for saturation temperature and pressure. This limits the correlation's ability to provide much detail about other fluid properties that may be of interest in the larger scheme of fluid analysis. An approach that can calculate the saturation boundary and be more generalized and flexible for a broader range of analyses would be very desirable.

According to one embodiment, and as illustrated at block 108, the critical temperature of brine can be estimated as a function of salt concentration through the use of the Haas correlation. Thus, at block 208, the PR EOS calculated parameter include the critical temperature.

Turning now to block 210, cubic EOS models are frequently used in reservoir engineering applications and processes due to their ability to provide reliable calculations, be generalized to many components, and be used in a predictive manner for many different applications. A commonly used cubic EOS model form is the Peng-Robinson (PR) EOS model which may be utilized in block 210 and was developed from the modified van der Waals equation of state. The generic form can be expressed as:

$$P = \frac{RT}{V - {b}_{EOS}} - \frac{{a}_{EOS} α}{V ( V + {b}_{EOS} ) + {b}_{EOS} ( V - {b}_{EOS} )} \qquad ( 6 )$$

where R is the universal gas constant and V is volume. This can be rewritten as:

Z³−(1+B−u₁B)Z²+(A+u₂B²−u₁B−u₁B²)Z−(AB−u₂B²−u₂B³)=0. (7)

The coefficients A, B, and Z are defined as:

$$\begin{matrix}A = \frac{{( {a}_{EOS , i} α )}_{m} P}{{( RT )}^{2}} & ( 8 ) \\ B = \frac{{b}_{EOS , i} P}{RT} & ( 9 ) \\ Z = \frac{PV}{RT} . & ( 10 )\end{matrix}$$

The cubic EOS parameters a_{EOS}, b_{EOS}, and a are defined as:

$$\begin{matrix}{a}_{EOS , i} = {Ω}_{a} \frac{{R}^{2} {T}_{ci}^{2}}{{P}_{ci}} & ( 11 ) \\ {b}_{EOS , i} = {Ω}_{b} \frac{{RT}_{ci}}{{P}_{ci}} & ( 12 ) \\ {α}_{i} = {[ 1 + {m}_{i} ( 1 - \sqrt{{T}_{ri}} ) ]}^{2} & ( 13 )\end{matrix}$$

where T_{c} is the critical temperature, P_{c} is the critical pressure, and Tᵣ is the reduced temperature (T/T_{c}). The subscripts i and m refer to individual components and mixture values, respectively. The values of Ωₐ, Ω_{b}, u₁, u₂, and m are model form dependent and are defined for the PR EOS as:

$${m}_{i} ( {ω}_{i} ) = \{ \begin{matrix}\begin{matrix}0.379642 + 1.48503 {ω}_{i} - \\ 0.1644 {ω}_{i}^{2} + 0.16667 {ω}_{i}^{3}\end{matrix} & {ω}_{i} > 0.49 \\ 0.379642 + 1.54226 {ω}_{i} - 0.2699 {ω}_{i}^{2} & {ω}_{i} \leq 0.49\end{matrix} \\ {Ω}_{a} = 0.45724 \\ {Ω}_{b} = 0.00780 \\ {u}_{1} = 2 \\ {u}_{2} = - 1 \qquad ( 14 )$$

With equations (6)-(14) as outlined above, the properties of a fluid including volumetric properties and vapor-liquid equilibrium can be calculated by using a number of well-documented solution methodologies. Herein, in the case where the measured temperature of the brine is greater than 573K, the critical temperature T_{c} is calculated per Hass as indicated at blocks 204 and 208. In one embodiment, the method used in the calculations of block 210 is the successive substitution iterative solution of the Rachford-Rice equation. This method is well-documented in the open literature and thus is not repeated in detail here.

In the alternative case (e.g., where T<573K) the Søreide and Whitson modified EOS parameters are used. In particular, as opposed to as is described above, calculations as implemented in block 206 utilize an a that is expressed as:

α^{1/2}=1+0.4530[1−Tᵣ(1−0.0103x^{1.1})]+0.0034(Tᵣ⁻³−1) (15)

where x is again the molality of the solution and Tᵣ is the reduced temperature. The critical temperature of pure water is used in this embodiment.

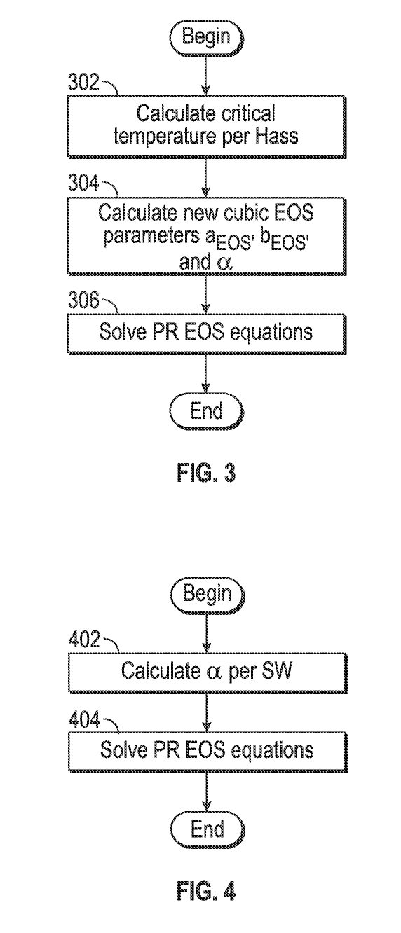

FIG. 3 shows a more detailed version of the calculations performed in blocks 208 and 210. At block 302 the critical temperature is calculated according to Hass. In one embodiment, the critical temperature (T_{c,Hass}) is calculated from:

$$ln {T}_{0} = \frac{ln {T}_{c , Hass}}{a + {bT}_{c , Hass}} + c \qquad ( 16 )$$

Where c is 0, and a and b are as expressed in equations 3 and 4 above.

At block 304 new cubic EOS parameters a_{EOS}, b_{EOS}, and a are calculated. This can be performed by defined as:

$$\begin{matrix}{a}_{EOS} = {Ω}_{a} \frac{{R}^{2} {T}_{c , Hass}^{2}}{{P}_{c}} & ( 17 ) \\ {b}_{EOS} = {Ω}_{b} \frac{{RT}_{c , Hass}}{{P}_{c}} & ( 18 ) \\ α = {[ 1 + {m}_{i} ( 1 - \sqrt{\frac{T}{{T}_{c , Hass}}} ) ]}^{2} & ( 19 )\end{matrix}$$

The values of Ωₐ, Ω_{b}, u₁, u₂, and m are model form dependent and are defined above.

At block 306 a flash solver can be used to solve for saturation at different pressures and temperatures based on equation 6 above.

FIG. 4 shows a more detailed version of the calculations performed in blocks 204 and 210. At block 402, a is calculated per SW as:

α^{1/2}=1+0.4530[1−Tᵣ(1−0.0103x¹¹)]+0.0034(Tᵣ⁻³−1) (15)

where Tᵣ=T/T_{c,Purewater}.

At block 404 a flash solver can be used to solve for saturation at different pressures and temperatures based on equation 6 above.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating saturation conditions of reservoir brines in an underground reservoir, the apparatus comprising:
a sensor for measuring a temperature of the brine; and
a processor, the processor configured to:
receive data representing the temperature;
determine if the temperature is greater than a preset value;
select either a first method or second method, different than the first method, of calculating the saturation conditions based on the determination,
wherein the first method is selected when the temperature is greater than the preset value and the second method is selected when the temperature is less than the preset value; and
based on results of the first or second method, form the saturation condition estimates utilizing an equation of state (EOS) model.

2. The apparatus of claim 1, wherein the processor determines a critical temperature (T_{c}) of water when the first method is selected.

3. The apparatus of claim 2, wherein:
$$ln {T}_{0} = \frac{ln {T}_{c}}{a + {bT}_{c}}$$
where T₀ is the measured temperature and a and b are constants based on a molality of the brine.

4. The apparatus of claim 3, wherein T_{c} is used to calculate values for one or more cubic equation of state EOS parameters a_{EOS}, b_{EOS}, and α.

5. The apparatus of claim 4, wherein the EOS model take the form:
$$P = \frac{RT}{V - {b}_{EOS}} - \frac{{a}_{EOS} α}{V ( V + {b}_{EOS} ) + {b}_{EOS} ( V - {b}_{EOS} )}$$

6. The apparatus of claim 1, wherein a first EOS parameter (a) is calculated according to the second method.

7. The apparatus of claim 6, wherein:
α^{1/2}=1+0.4530[1−Tᵣ(1−0.0103x¹¹)]+0.0034(Tᵣ⁻³−1)
where Tᵣ is equal to the measured temperature divided by a critical temperature of pure water.

8. The apparatus of claim 7, wherein cubic equation of state EOS parameters a_{EOS}, and b_{EOS} are calculated from:
$$\begin{matrix}{a}_{EOS} = {Ω}_{a} \frac{{R}^{2} {T}_{c}^{2}}{{P}_{c}} ; and \\ {b}_{EOS} = {Ω}_{b} \frac{{RT}_{c}}{{P}_{c}}\end{matrix}$$
where T_{c} is the critical temperature of pure water, P_{c} the critical pressure of pure water and Ωₐ and Ω_{b} are constants.

9. The apparatus of claim 8, wherein the EOS model takes the form:
$$P = \frac{RT}{V - {b}_{EOS}} - \frac{{a}_{EOS} α}{V ( V + {b}_{EOS} ) + {b}_{EOS} ( V - {b}_{EOS} )} .$$

10. A computer based method of estimating saturation conditions of reservoir brines in an underground reservoir, the method comprising:
receiving at the computing device data representing a temperature of the brine;
determining with the computing device if the temperature is greater than a preset value;
selecting either a first method or second method, different than the first method, of calculating the saturation conditions based on the determination,
wherein the first method is selected when the temperature is greater than the preset value and the second method is selected when the temperature is less than the preset value; and
based on results of the first or second method, forming the saturation condition estimates utilizing an equation of state (EOS) model.

11. The method of claim 10, wherein the processor determines a critical temperature (T_{c}) of water when the first method is selected.

12. The method of claim 11, wherein:
$$ln {T}_{0} = \frac{ln {T}_{c}}{a + {bT}_{c}}$$
where T₀ is the measured temperature and a and b are constants based on a molality of the brine.

13. The method of claim 12, wherein T_{c} is used to calculate values for one or more cubic equation of state EOS parameters a_{EOS}, b_{EOS}, and α.

14. The method of claim 13, wherein the EOS model take the form:
$$P = \frac{RT}{V - {b}_{EOS}} - \frac{{a}_{EOS} α}{V ( V + {b}_{EOS} ) + {b}_{EOS} ( V - {b}_{EOS} )}$$

15. The method s of claim 10, wherein a first EOS parameter (a) is calculated according to the second method.

16. The method of claim 15, wherein:
α^{1/2}=1+0.4530[1−Tᵣ(1−0.0103x¹¹)]+0.0034(Tᵣ⁻³−1)
where Tᵣ is equal to the measured temperature divided by a critical temperature of pure water.

17. The method of claim 16, wherein cubic equation of state EOS parameters a_{EOS}, and b_{EOS} are calculated from:
$$\begin{matrix}{a}_{EOS} = {Ω}_{a} \frac{{R}^{2} {T}_{c}^{2}}{{P}_{c}} ; and \\ {b}_{EOS} = {Ω}_{b} \frac{{RT}_{c}}{{P}_{c}}\end{matrix}$$
where T_{c} is the critical temperature of pure water, P_{c} the critical pressure of pure water and Ωₐ and Ω_{b} are constants.

18. The method of claim 17, wherein the EOS model takes the form:
$$P = \frac{RT}{V - {b}_{EOS}} - \frac{{a}_{EOS} α}{V ( V + {b}_{EOS} ) + {b}_{EOS} ( V - {b}_{EOS} )} .$$
